(19) United States
(12) Patent Application Publication
(10) Pub. No.: US 2002/0126792 A1
(43) Pub. Date: Sep. 12, 2002

(54) Electric or electronic circuit arrangement and method of protecting said circuit arrangement from manipulation and/or abuse

(76) Inventors: Johann Fuhrmann, Hildesheim (DE); Ernst Bretschneider, Erfurt (DE); Walter Einfeldt, Uetersen (DE)

Correspondence Address: U.S. Philips Corporation, 580 White Plains Road, Tarrytown, NY, 10591, US

(21) Appl. No.: 10/043,516

(22) Filed: Jan. 11, 2002

(30) Foreign Application Priority Data
Jan. 13, 2001 (DE) 10101330.2

(51) Int. Cl. G06M 3/00

(52) U.S. Cl. 377/1

(57) ABSTRACT

To provide an electric or electronic circuit arrangement (100), it is proposed that at least one signal-generating unit (40), particularly at least an oscillator unit is connected to the contact terminals (22, 27) of the integrated circuit, the output frequency (f_{meas.}) of which unit is substantially determined by the specific capacitance (C), the signal-generating unit (40) precedes at least a first counting unit (50) which is clocked at the output frequency (f_{meas.}) of the signal-generating unit (40), in which counting unit an actual value count can be determined after a predetermined temporal counting period, at least a second counting unit (55) clocked at a reference frequency (f_{ref}) is provided, in which counting unit a nominal value count can be determined after the predetermined temporal counting period, the first counting unit (50) and the second counting unit (55) precede at least one comparator unit (60) for comparing the actual value count with the nominal value count, while the functions of the integrated circuit can be blocked and/or locked and/or interrupted temporarily or permanently in the case of an error indication which occurs when the actual value count is compared with the nominal value count.

The present invention relates to an electric or electronic circuit arrangement comprising at least one, particularly layered carrier substrate of a semiconducting or insulating material, at least one integrated circuit constituted by at least two spaced, particularly lithographically applied conductor tracks on the carrier substrate, at least one dielectric shielding layer, particularly an insulation layer and/or passivation layer and/or a further protective layer situated between the conductor tracks and/or laterally with respect to the conductor tracks and/or on the conductor tracks, provided for protecting the integrated circuit from external influences so that the integrated circuit has a specific, particularly lateral and/or particularly parasitic capacitance determined by the dielectric shielding layer.

The invention also relates to a method of protecting an electric or electronic circuit arrangement formed in this way from manipulation and/or abuse.

In connection with the protection from manipulation and/or abuse, the general trend is that the security requirements, particularly in the field of the smart card chip technique, become more stringent with an increasing use of smart cards such as, for example, bank cards, sickfund cards or various security chip cards. All of these chip cards have in common that sensitive data are stored which should be solely and exclusively accessible to the authorized user of the chip card within the scope defined hereinbefore. In this connection, it is usually the aim of unauthorized persons to read information from the chip card or analyze the functional components of the chip so as to use the chip card for abusive purposes.

A manipulative possibility of obtaining unauthorized information about the structure and/or the function of chip cards is offered by the chemical or mechanical removal of the dielectric shielding layer, particularly the passivation layer, for the purpose of electrical or electronical analysis by means of touching the conductor tracks with (measuring) needles to be put on the conductor tracks and/or for the purpose of optical analysis of the functional components by means of a microscope. In this way, software-defined barriers may be at least partly overcome without authorization. To be able to satisfy the security requirements resulting from these risks of abuse, a concept will be required which combines active and passive security structures such as (photo)sensors and passivation layers.

An arrangement of the type described in the opening paragraph is known from DE 197 38 990 A1. In the arrangement for protecting a chip card from abuse, as described in this document, the dielectrical properties of a passivation layer on the chip of a chip card are scanned by means of a capacitance influenced by the passivation layer. To this end, an oscillator is used whose oscillation frequency is determined by said capacitance. The actual oscillation frequency is compared with a nominal value by clocking a counter in a given time interval and the final count is used as a measure for the actual oscillation frequency.

The number of the count made available by the counter may additionally be combined with a personal, specific number by means of a freely selectable combination algorithm so as to obtain a further number, and the number made available by the counter or the further number may be optionally compared with a reference value.

It is true that this known arrangement implies a number of advantages such as the possibility of preventing abuse due to chip manipulation by means of sensitive capacitance scanning in the capacitance arrangement in the dielectric protective layer shielding the chip, but the envisaged “capacitate sensor” in the arrangement disclosed in DE 197 38 990 A1 is not obtained until after the chip to be protected has been mounted on a card by providing an appropriate protective lacquer and is capable of functioning in this way only.

Based on these drawbacks and shortcomings of the conventional arrangements, it is an object of the present invention to provide an electric or electronic circuit arrangement of the type described in the opening paragraph, as well as a method of protecting an electric or electronic circuit arrangement from manipulation and/or abuse, in which, in contrast to the prior art, a complete integration of the envisaged “capacitive detector” in the (semiconductor) chip is possible without electric connections to the exterior—possibly via contact pads—being required and independent of the fact how the (semiconductor) chip is eventually used. Furthermore, elaborate assembling operations in the actual manufacture of the chip cards are prevented by using the present invention.

This object is solved by the characteristic features defined in claim 1 for an electric or electronic circuit arrangement and by a method, defined in claim 12, of protecting an electric or electronic circuit arrangement from manipulation and/or abuse. Advantageous, further embodiments of the present invention are defined in the dependent claims.

In accordance with the teaching of the present invention, the “capacitive detector”, which may also be referred to as “passivation layer sensor”, prevents or at least impedes manipulative attacks on an integrated circuit constituted by at least two spaced conductor tracks provided particularly lithographically on a carrier substrate. In this connection, the concept of the “capacitive detector” or “passivation layer sensor” is based on the use of lateral parasitic capacitances which result from the neighborhood of the at least two conducting, preferably mutually independent conductor tracks.

When the at least one dielectric shielding layer, particularly in the form of at least an insulation layer and/or at least a passivation layer and/or at least a further protective layer, provided for protecting the integrated circuit from external influences, is at least partially removed for manipulative and/or abusive purposes by an unauthorized person, the relative dielectricity value of the insulation layer and/or passivation layer and/or further protective layer situated between the conductor tracks and/or laterally to the conductor tracks and/or on the conductor tracks will be changed. This change Δεᵣ of the relative dielectricity value leads to a change ΔC of the specific capacitance in accordance with the formula ΔC=ε₀·Δεᵣ·h·1/d, in which

ε₀=8.8542.10⁻¹² A s V⁻¹ m⁻¹ is the field constant,

h is the height of the conductor tracks,

l is the length of the conductor tracks, and

d is the distance between the first conductor track and the second conductor track.

When the passivation layer has a relative dielectricity value εᵣ of 3.9 or even 7.5 in the case of a shielding silicon nitrite layer, this relative dielectricity value changes after complete removal of the passivation layer to ε_{r,Luft}=1, i.e. the lateral parasitic capacitances resulting from the neighborhood of the at least two conducting, preferably mutually independent conductor tracks change by a high factor.

The evaluation of this capacitance change may be realized as an absolute measurement or as a relative measurement. When the lateral parasitic capacitance is integrated in an appropriate oscillator circuit such as, for example, an RC oscillator circuit or an LC oscillator circuit, a capacitive sensor can be realized to some extent by evaluating the frequency change resulting from the dielectricity change.

A differential evaluation of the capacitance change described hereinbefore is realized in two steps.

In a first step, the “passivation layer sensor” formed by at least two conductor tracks suitably arranged in parallel and covered by at least one passivation layer is connected to at least one signal-generating unit, particularly to at least one oscillator unit. The capacitance change causes a change of the oscillation frequency.

In a second step, at least two preferably digital counting units are used, in which a first counting unit is clocked at the output frequency of the signal-generating unit, and a second counting unit is clocked at a reference frequency. When the first counting unit reaches a given predetermined value, the count between the first counting unit and the second counting unit is compared in at least one comparator unit. In the normal case (dielectric shielding layer is neither chemically nor mechanically attacked, or not removed, i.e. the dielectric shielding layer is in good order) the comparison of the count does not lead to an error indication, whereas in the case of manipulation or abuse (dielectric shielding layer is chemically and/or mechanically attacked or removed, i.e. the dielectric shielding layer is out of order) an error indication is generated from the resultant changed frequency.

In summary, it can be concluded that the present invention provides an electric or electronic circuit arrangement as well as a method of protecting an electric or electronic circuit arrangement from manipulation and/or abuse in which—as a delimitation of the arrangement disclosed in DE 197 38 990 A1—a complete integration of the envisaged “capacitive detector” in the (semiconductor) chip is possible without electric connections to the exterior—possibly via contact pads—being required and independent of the fact how the (semiconductor) chip is eventually used. Furthermore, the present invention precludes elaborate assembling operations in the actual manufacture of the chip cards.

These and other aspects of the invention are apparent from and will be elucidated with reference to the embodiments described hereinafter.

In the drawings:

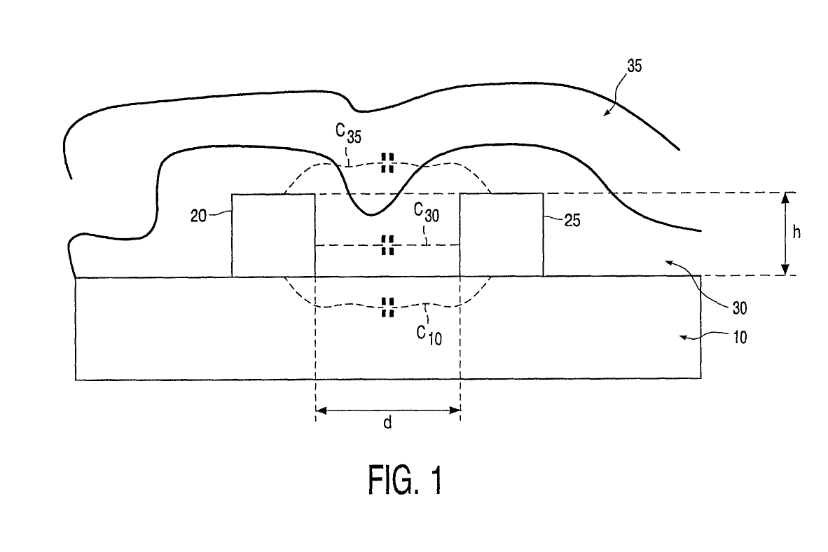

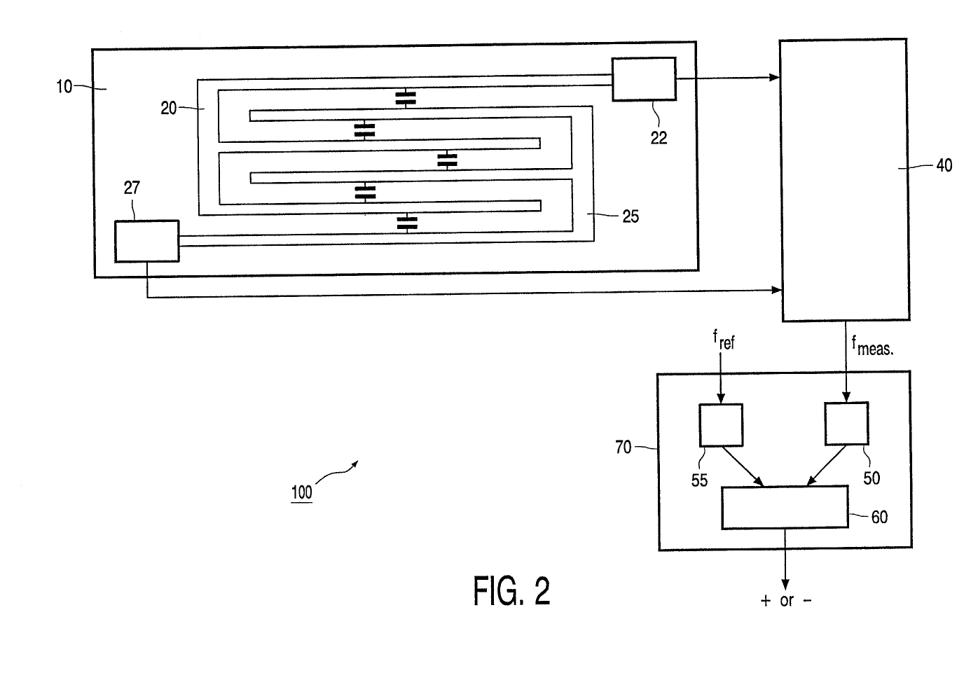

FIG. 1 shows, in a diagrammatical cross-section, an integrated circuit constituted by two spaced conductor tracks provided on a carrier substrate, and FIG. 2 shows diagrammatically an embodiment of a circuit arrangement in accordance with the present invention.

Identical or similar embodiments, elements or characteristic features are denoted by identical reference signs in FIGS. 1 and 2.

The circuit arrangement 100, shown in FIG. 2, to be implemented and/or integrated in a chip card or smart card comprises a layered carrier substrate 10 of a semiconducting material including processed circuits and conductor tracks up to the penultimate metal plane, as is shown in FIG. 1 in a cross-section. Accordingly, an integrated circuit constituted by two spaced (d) conductor tracks 20, 25 provided lithographically and arranged sectionally parallel to each other and/or in a meandering intermeshing configuration, in which a first dielectric shielding layer in the form of a passivation layer 30 for protecting the integrated circuit from external influences (cf. FIG. 1) is provided between and laterally to the conductor tracks 20, 25.

A dielectric shielding layer in the form of a further protective layer 35, also for protecting the integrated circuit from external influences, is further provided on the conductor tracks 20, 25, so that the integrated circuit has a specific lateral parasitic capacitance C=C₁₀+C₃₀+C₃₅ substantially determined by the two dielectric shielding layers 30, 35 formed from an opaque material (C₁₀ is the specific capacitance of the carrier substrate 10).

When one or both dielectric shielding layers in the form of the passivation layer 30 and the further protective layer 35 are at least partially removed, the relative dielectricity value of the dielectric shielding layers situated between the conductor tracks 20, 25, laterally to the conductor tracks 20, 25 and on the conductor tracks 20, 25 changes.

Since the signal-generating unit 40 in the form of an oscillator unit (=oscillator circuit consisting of a capacitive unit, namely a capacitor, and a resistive unit, namely a resistor) is connected to the contact terminals 22 and 27 of the conductor tracks 20 and 25, respectively, in which the output frequency f_{meas.} of this unit is defined by the specific capacitance C=C₁₀+C₃₀+C₃₅, the specific capacity change ΔC=ε₀·Δεᵣ·h·1/d caused by the change of the relative dielectricity value Δεᵣ acts immediately on the output frequency f_{meas.} generated in the signal-generating unit 40.

This signal-generating unit 40 in the form of the RC oscillator unit operates in a reliable manner within a wide voltage and temperature range and at a low current consumption.

The system frequency which is necessary for operating the chip may be utilized as the reference frequency f_{ref}. A further possibility is the use of an additional oscillator having a structure which is similar to that of the oscillator for the measuring frequency, whose frequency-determining elements are, however, accommodated in another insulating layer.

An essential advantage of the signal-generating unit 40 in the form of the RC oscillator unit is the large voltage and temperature range in which the RC oscillator unit operates. When the “capacitive detector”, which may also be referred to as “passivation layer sensor”, is removed, the oscillation is not interrupted or oscillates at an infinitely large frequency, but is only increased to a multiple of the previous normal frequency.

The signal-generating unit 40 precedes a first digital counting unit 50 clocked at the output frequency f_{meas.} of the signal-generating unit 40 (cf. FIG. 2) in which an actual value count can be determined after a predetermined temporal counting period. The circuit arrangement 100 also comprises a second digital counting unit 55 clocked at a reference frequency f_{ref}, in which a nominal value count can be determined after the predetermined temporal counting period.

In the comparator unit 60, which is preceded by the first counting unit 50 and the second counting unit 55, the actual value count is then compared with the nominal value count, while the functions of the integrated circuit can be blocked and/or locked and/or interrupted temporarily or permanently in the case of an error indication which occurs when the actual value count is compared with the nominal value count (symbol “−” in FIG. 2; when there is no error indication: symbol “+” in FIG. 2), because in this case there is a change of the relative dielectricity value, i.e. a capacitance change, i.e. a frequency shift due to a manipulative and/or abusive attack on the shielding layer dielectric in accordance with the correlations described hereinbefore.

As can also be seen in FIG. 2, a differential evaluation unit 70 is constituted by the first counting unit 50, the second counting unit 55 and the comparator unit 60. This differential evaluation unit 70 is consequently implemented for determining the change of the specific capacitance C caused by an at least partial removal of the dielectric shielding layers 30, 35, which evaluation unit 70 specifically generates the error indication when the actual value deviates from the nominal range.

For a practical realization of the circuit arrangement 100 in accordance with the present invention, it is finally to be noted that the value of the specific capacitance C is dependent on the envisaged oscillator frequency f_{meas.} with the computation of the lateral parasitic capacitance C being based on the equivalent circuit diagram shown in FIGS. 1 and 2. For example, it has proved that a lateral capacitance of about 29.7.10⁻¹² F m⁻¹ is obtained in the layout when the conductor tracks 20, 25 have a distance d of about two micrometers.

List of Reference Signs

| | |
|---|---|
| 100 | electric or electronic circuit arrangement |
| 10 | carrier substrate |
| 20 | first conductor track |
| 22 | contact terminal of the first conductor track 20 |
| 25 | second conductor track |
| 27 | contact terminal of the second conductor track 25 |
| 30 | first dielectric shielding layer, particularly passivation layer |
| 35 | second dielectric shielding layer, particularly further protective |
| | layer |
| 40 | signal-generating unit, particularly oscillator unit |
| 50 | first counting unit |
| 55 | second counting unit |
| 60 | comparator unit |
| 70 | evaluation unit |
| C | specific capacitance |
| ΔC | change of the specific capacitance |
| C₁₀ | specific capacitance of the carrier substrate 10 |
| C₃₀ | specific capacitance of the first dielectric shielding layer 30 |
| C₃₅ | specific capacitance of the second dielectric shielding layer 35 |
| d | distance between the first conductor track 20 and the second |
| | conductor track 25 |
| ε₀ | field constant (ε₀ = 8.8542 · 10⁻¹² A s V⁻¹ m⁻¹) |
| ε₁ | relative dielectricity value |
| Δεᵣ | change of the relative dielectricity value |
| f_{meas.} | output frequency of the signal-generating unit 40 |
| f_{ref} | reference frequency |
| 1 | length of the conductor tracks 20, 25 |
| SiNO₂ | silicon nitrite |
| SiO₂ | silicon dioxide |

1. An electric or electronic circuit arrangement (100) comprising at least one, particularly layered carrier substrate (10) of a semiconducting or insulating material, at least one integrated circuit constituted by at least two spaced, particularly lithographically applied conductor tracks (20, 25) on the carrier substrate (10), at least one dielectric shielding layer (30; 35), particularly an insulation layer and/or passivation layer (30) and/or a further protective layer (35) situated between the conductor tracks (20, 25) and/or laterally with respect to the conductor tracks (20, 25) and/or on the conductor tracks (20, 25), provided for protecting the integrated circuit from external influences so that the integrated circuit has a specific, particularly lateral and/or particularly parasitic capacitance (C) determined by the dielectric shielding layer (30; 35), characterized in that at least one signal-generating unit (40), particularly at least an oscillator unit is connected to the contact terminals (22, 27) of the integrated circuit, the output frequency (f_{meas.}) of which unit is substantially determined by the specific capacitance (C), in that the signal-generating unit (40) precedes at least a first counting unit (50) which is clocked at the output frequency (f_{meas.}) of the signal-generating unit (40), in which counting unit an actual value count can be determined after a predetermined temporal counting period, in that at least a second counting unit (55) clocked at a reference frequency (f_{ref}) is provided, in which counting unit a nominal value count can be determined after the predetermined temporal counting period, in that the first counting unit (50) and the second counting unit (55) precede at least one comparator unit (60) for comparing the actual value count with the nominal value count, while the functions of the integrated circuit can be blocked and/or locked and/or interrupted temporarily or permanently in the case of an error indication which occurs when the actual value count is compared with the nominal value count.

2. A circuit arrangement (100) as claimed in claim 1, characterized in that the conductor tracks (20, 25) are at least sectionally arranged parallel to each other and/or in a meandering intermeshing configuration.

3. A circuit arrangement (100) as claimed in claims 1 or 2, characterized in that the mutual distance (d) between the conductor tracks (20, 25) is in the micrometer range.

4. A circuit arrangement (100) as claimed in any one of claims 1 to 3, characterized in that the material of the dielectric shielding layer (30; 35) is epoxy resin or silicon nitrite (SiNO₂) or silicon dioxide (SiO₂) or consists of other insulating layers used in the manufacture of semiconductors.

5. A circuit arrangement (100) as claimed in any one of claims 1 to 4, characterized in that the material of the dielectric shielding layer (30; 35) is also opaque.

6. A circuit arrangement (100) as claimed in any one of claims 1 to 5, characterized in that the signal-generating unit (40) comprises at least one oscillator circuit consisting of at least one capacitive unit, particularly a capacitor, and at least one resistive unit, particularly a resistor, and/or at least one oscillator circuit consisting of at least one capacitive unit, particularly a capacitor, and at least one inductive unit, particularly a coil.

7. A circuit arrangement (100) as claimed in any one of claims 1 to 6, characterized in that at least an evaluation unit (70), particularly at least a differential evaluation unit is constituted by the first counting unit (50), the second counting unit (55) and the comparator unit (60).

8. A circuit arrangement (100) as claimed in claim 7, characterized in that the evaluation unit (70) is implemented to detect a change of the specific capacitance (C) caused by an at least partial removal of the dielectric shielding layer (30; 35).

9. A circuit arrangement (100) ad claimed in claim 7 or 8, characterized in that the evaluation unit (70) generates the error indication when the actual value deviates from the nominal range.

10. A circuit arrangement (100) as claimed in any one of claims 1 to 9, characterized in that the first counting unit (50) and/or the second counting unit (55) is formed on a digital basis.

11. A card, particularly a chip card or smart card, comprising at least an electric or electronic circuit arrangement (100) as claimed in any one of claims 1 to 10.

12. A method of protecting an electric or electronic circuit arrangement (100) formed in accordance with the precharacterizing part of claim 1, from manipulation and/or abuse, characterized in that an output frequency (f_{meas.}) determined by the specific capacitance (C) is generated in at least one signal-generating unit (40), particularly in at least an oscillator unit, in that an actual value count is determined after a predetermined temporal counting period in at least a first counting unit (50) clocked at the output frequency (f_{meas.}) of the signal-generating unit (40), in that a nominal value count is determined after the predetermined temporal counting period in at least a second counting unit (55) clocked at a reference frequency (f_{ref}), in that the actual value count is compared with the nominal value count, and in that the functions of the integrated circuit are blocked and/or locked and/or interrupted temporarily or permanently in the case of an error indication which occurs when the actual value count is compared with the nominal value count in at least one comparator unit (60).

13. A method as claimed in claim 12, characterized in that at least an evaluation unit (70) constituted by the first counting unit (50), the second counting unit (55) and the comparator unit (60) operates on a differential basis.

14. A method as claimed in claim 13, characterized in that a change of the specific capacitance (C) caused by an at least partial removal of the dielectric shielding layer (30; 35) is detected in the evaluation unit (70).

15. A method as claimed in claim 13 or 14, characterized in that the error indication is generated in the evaluation unit (70) when the actual value deviates from the nominal range.
